(19) United States
(12) Patent Application Publication
(10) Pub. No.: US 2026/0350071 A1
(43) Pub. Date: Nov. 5, 2026

(54) SEAMLESS ENHANCEMENT OF AI RESPONSE GENERATION

(71) Applicant: The Toronto-Dominion Bank, Toronto (CA)

(72) Inventors: Anil Stewart Bakhle, Guelph (CA); Christopher Robert Halabecki, St. George Brant (CA)

(73) Assignee: The Toronto-Dominion Bank, Toronto, ON (CA)

(21) Appl. No.: 19/194,128

(22) Filed: Apr. 30, 2025

(51) Int. Cl. G06F 16/334; G06F 3/04845; G06F 16/955; G06F 40/295; G06F 40/30

(52) U.S. Cl. CPC G06F 16/3344; G06F 3/04845; G06F 16/9558; G06F 40/295; G06F 40/30

(57) ABSTRACT

An example operation may include at least one of receiving a natural language query from a source device, generating a response to the natural language query based on execution of a first artificial intelligence (AI) model on the natural language query, generating supplemental content which is related to the natural language query based on execution of a second AI model on the natural language query, generating a combined supplemental response that includes the response and the supplemental content, and outputting the combined supplemental response to the source device. The example operation may further include an AI agent that performs an action based on the combined supplemental response.

### BACKGROUND

Various artificial intelligence (AI) models, such as large language models (LLMs), are able to provide answers based on queries or prompts. Sensitive data or confidential data should not be input into the AI models, as the data may become public or may be used to further train the AI models. In some cases, models can be restricted to prevent consumption of sensitive data during input. However, the missing input data may prevent the model from providing a complete response to the query.

### SUMMARY

One example embodiment provides an apparatus that may include a memory, and at least one processor communicably coupled to the memory, where the at least one processor may at least one of receive a natural language query from a source device, generate a response to the natural language query based on execution of a first AI model on the natural language query, generate supplemental content which is related to the natural language query based on execution of a second AI model on the natural language query, generate a combined supplemental response that includes the response and the supplemental content, and output the combined supplemental response to the source device.

Another example embodiment provides a method that includes at least one of receiving a natural language query from a source device, generating a response to the natural language query based on execution of a first AI model on the natural language query, generating supplemental content which is related to the natural language query based on execution of a second AI model on the natural language query, generating a combined supplemental response that includes the response and the supplemental content, and outputting the combined supplemental response to the source device.

A further example embodiment provides a computer-readable medium comprising instructions, that when read by a processor, cause the processor to perform at least one of receiving a natural language query from a source device, generating a response to the natural language query based on execution of a first AI model on the natural language query, generating supplemental content which is related to the natural language query based on execution of a second AI model on the natural language query, generating a combined supplemental response that includes the response and the supplemental content, and outputting the combined supplemental response to the source device.

### BRIEF DESCRIPTION OF THE DRAWINGS

FIG. 1A is a diagram illustrating a process of augmenting input data for execution by a remote AI model according to examples and features of the instant solution.

FIG. 1B is a diagram illustrating a process of generating a response based on code from the remote AI model according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 3 is a system diagram illustrating an operating environment for a communication service according to the examples and features of the instant solution.

FIG. 4A is a diagram illustrating a process of generating supplemental content in parallel with generating a response to a natural language input according to the examples and features of the instant solution.

FIG. 4B is a diagram illustrating a process of generating supplemental content with supplemental data according to the examples and features of the instant solution.

FIG. 5A is a diagram illustrating a process of generating both supplemental image and supplemental text content according to the examples and features of the instant solution.

FIG. 5B is a diagram illustrating a process of combining and outputting the supplemental content according to the examples and features of the instant solution.

FIG. 6A is a diagram illustrating a method of generating a response with supplemental content according to the examples and features of the instant solution.

FIG. 6B is a diagram illustrating an additional method of generating a response with supplemental content according to the examples and features of the instant solution.

FIG. 7 is a diagram illustrating a computing system that may be used in any of the example embodiments described herein.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to an artificial intelligence (AI) system that can generate a response to a natural language query and also provide supplemental content with the response to enhance the response. The supplemental content may be content that is not directly requested by the natural language query but that the system determines is related. For example, the supplemental content may include an object, a product, a service, or the like, which can help the person asking the question, but which the person is not asking for directly. In this way, the system intuitively detects supplemental content to generate and output to a source device using artificial intelligence.

According to various embodiments, the system may receive a natural language query from a source device. In response, the system may generate a response to the natural language query based on execution of a first AI model on the natural language query. Here, the first AI model may generate a textual-based natural language response to the natural language query. Furthermore, the system may also generate supplemental content which is related to the natural language query based on execution of a second AI model on the natural language query and a supplemental content database.

According to various embodiments, the second AI model may be trained to identify related data that is not directly on topic but which is relevant and potentially useful based on the content within the natural language query. The supplemental content database may include additional data about possible objects, products, services, and the like, that may be of interest to the person. The system may generate a combined supplemental response that includes the response and the supplemental content, and output the combined supplemental response to the source device.

In some embodiments, the system may generate a supplemental image that is associated with the natural language query based on the execution of the second AI model and combine the supplemental image with the response on a graphical user interface (GUI). For example, the query may request information about a specific item, and the second AI model may generate image content about a related location where the item can be found, purchased, etc. In some embodiments, the system may identify a topic of the natural language query based on the execution of the first AI model, and generate additional content about the topic based on execution of the second AI model on the topic. For example, the topic may be related to entertainment, financial, business, investment, etc. The system may extract additional content about the topic from the supplemental database, and generate supplemental content about the topic to further enhance the answer response.

In some embodiments, the system may identify a profile associated with the source device, extract profile content from the profile, and further generate the supplemental content based on execution of the second AI model on the profile content. The system may identify a name within the natural language query, add a weight to the name, and generate the supplemental content based on execution of the second AI model on the weight added to the name. For example, the name may be the name of an item, the name of a person, the name of a product, the name of a service, or the like. As another example, the system may identify at least one of an object and a service that is related to the natural language query based on the execution of the second AI model, and generate content about the at least one of the object and the service based on the execution of the second AI model.

In some embodiments, the system may identify a webpage associated with the supplemental content and output the combined supplemental response with a hyperlink to the webpage. In some embodiments, the system may generate the response and generate the supplemental content based on simultaneous execution of the first AI model and the second AI model.

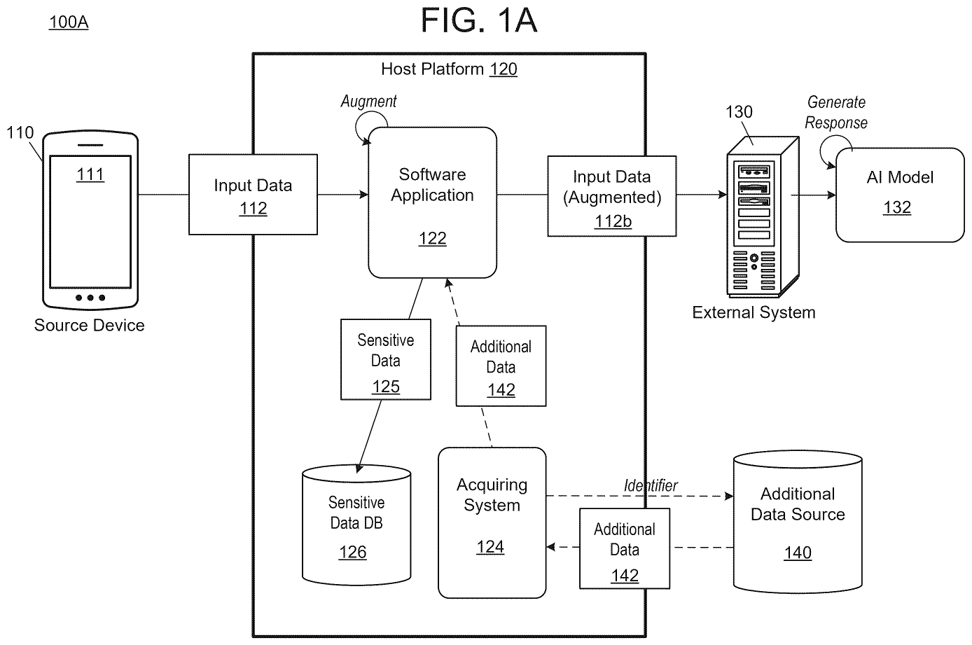

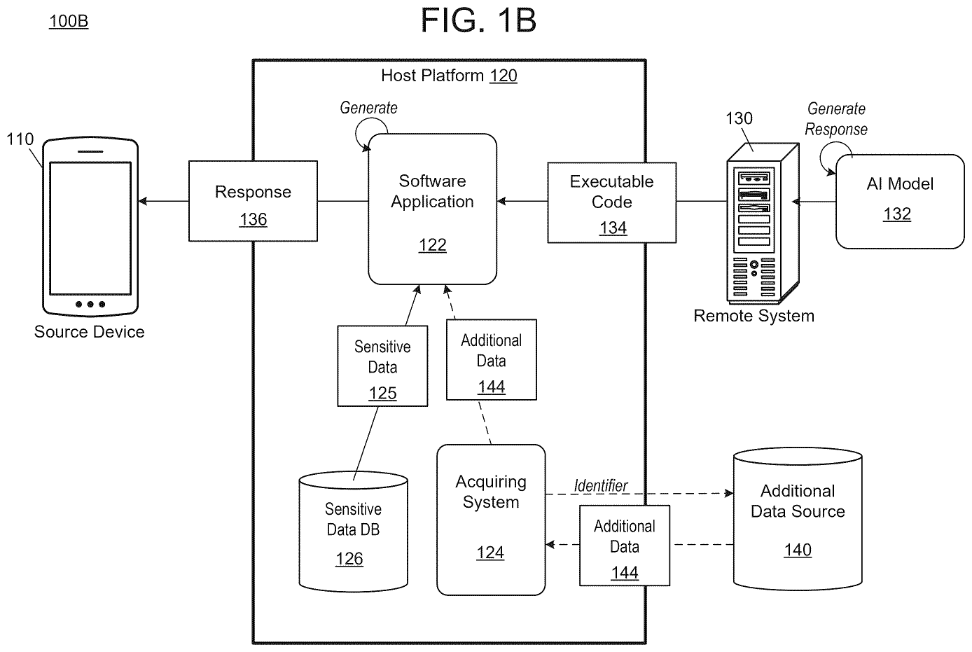

FIG. 1A illustrates a process 100A of augmenting input data for execution by a remote AI model according to examples and features of the instant solution. Referring to FIG. 1A, a host platform 120, such as a cloud platform, a web server, a database, a combination of systems, and the like, may host a software application 122 which relies on predictions/inferences made by an AI model 132 hosted by an external system 130. The software application 122 may have access to sensitive data (e.g., financial data, account numbers, personally identifiable information (PII), contact information, social security numbers, driver's licenses, credit card numbers, passwords, usernames, residence information, etc.) The sensitive data may be prevented, by laws, regulations, corporate policy, contractual agreements, and the like, from leaving possession of the host platform 120.

However, for various reasons, the host platform 120 may desire to use an AI model, such as the AI model 132, on a remote system. As one example, the host platform may not have its own AI model, such as an LLM. As another example, the host platform 120 may host its own AI model, but the AI model 132 hosted by the external system 130 may be more accurate at generating responses, faster, easier to scale with, and the like. Therefore, the host platform 120 may use the “non-sensitive” data from a user input to request a response from the AI model 132 hosted on the external system 130.

In the example of FIG. 1A, the host platform 120 may receive input data 112 submitted/uploaded from a source device 110. As an example, the input data 112 may be typed into a display device 111 using a touchpad, spoken and recorded by a microphone of the source device 110, or the like. The input data 112 may include a natural language query, or the like, along with personal information or the like. The source device 110 may include a mobile device, a laptop computer, a desktop computer, a tablet, or the like. The source device 110 may connect to the host platform 120 over a computer network, such as the Internet, a private network, a combination thereof, and the like. For example, the software application 122 may be a web application accessible at a predefined uniform resource locator (URL) with a browser such as a web browser, mobile browser, and the like.

The software application 122 may analyze the input data 112 and detect a portion of the input data 112 as sensitive data 125. For example, the sensitive data 125 may include personally-identifiable information (PII) such as a name, an address, an email address, a phone number, a social security number, an account number, a username, a password, a name of a family member, and the like. The sensitive data 125 may be redacted or otherwise removed from the input data 112 and temporarily stored within a sensitive data database 126 to generate augmented input data 112b. As another example, the software application 122 may also acquire or otherwise collect additional data about a question, about a source device, about an owner/user of the source device, and the like, from an additional data source 140 such as a publicly-available database.

For example, the software application 122 may use an acquiring system 124 to query the additional data source based on an identifier (e.g., name, device ID, account number, etc.) and obtain additional data 142 associated with the source device 110. The additional data 142 may be used to generate a response and/or augment a response. For example, the additional data 142 may be included in the augmented input data 112b that is transferred to the external system 130 over a network such as the Internet. The external system 130 may execute the AI model 132 on the augmented input data 112b to generate executable source code that can be executed by the software application 122 to generate a response to the input data 112.

FIG. 1B illustrates a process 100B of generating a response based on code from the remote AI model according to examples and features of the instant solution. Referring to FIG. 1B, the AI model 132 may generate executable source code 134 which can be executed by the software application 122 to generate a response 136 to a natural language query or the like within the input data 112.

For example, the augmented input data 112b that is fed to the AI model 132 may include instructions or task which specifies that the AI model 132 is to generate code in a predefined programming language (e.g., Python, etc.) which can be executed to generate an answer to the question. This ensures that the data used by the code during execution can be used from the host platform 120, where the sensitive data can reside, rather than the external system 130 which is prohibited. Thus, the example embodiments enable an AI model to generate a response without the exchange of sensitive data. However, the sensitive data can still be integrated back into the final response. For example, a local AI model may receive the response generated by the external AI model, and the sensitive data removed from the input data, and generate a more accurate response that can then be output to the source device.

In the example of FIG. 1B, the executable source code 134 is provided to the software application 122 from the external system 130. In addition, the sensitive data 125 is provided back to the software application 122 along with any additional data 144 that is desired from an external system such as the additional data source 140. In response, the software application 122 can execute the executable source code 134 on the input data 112 including the sensitive data 125 and any additional data 144 to generate a response 136. The response 136 may then be output to the source device 110 where it can be viewed on the display device 111 of the source device 110.

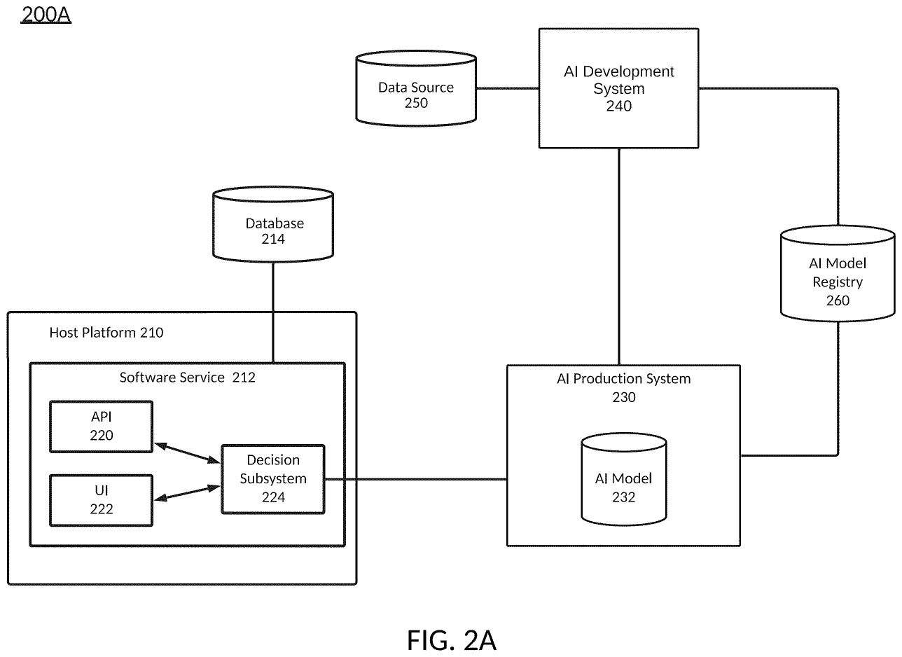

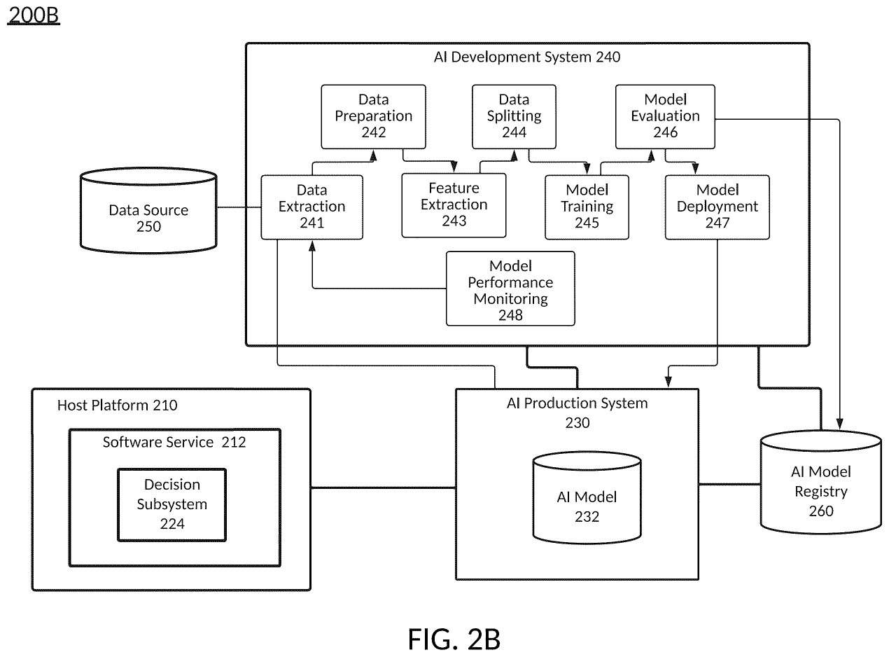

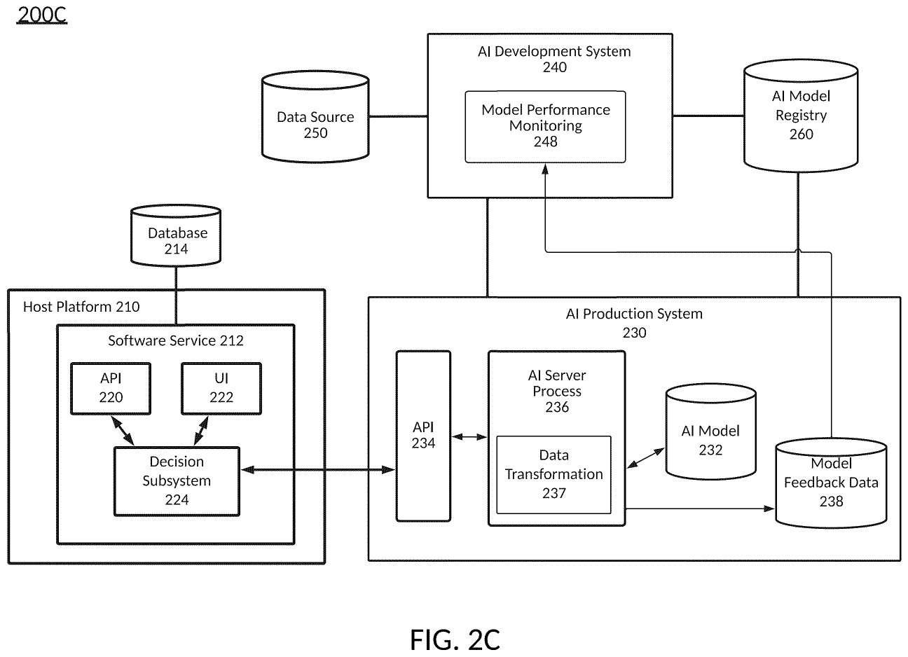

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIG. 2A), executing on host platform 210 may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 212 to assist in decision-making. In some examples and features of the instant solution, the software service 212 stores data included in API requests or data generated during processing the API requests into at least one database 214.

Software service 212 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 21,2 UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

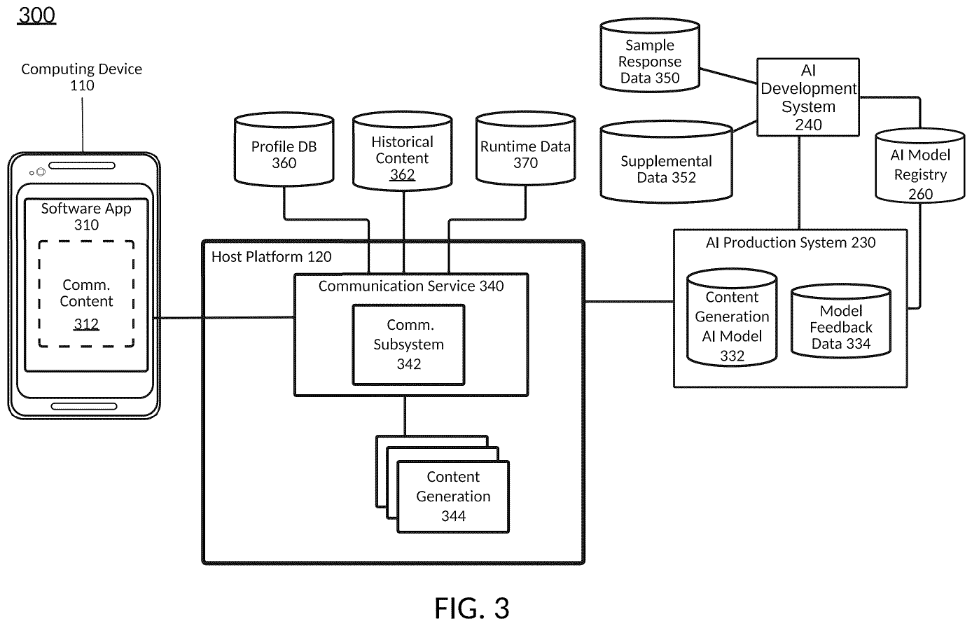

FIG. 3 illustrates an operating environment 300 for a communication service according to the examples and features of the instant solution. In some examples and features of the instant solution, a content generation AI model 332 is trained using at least one of historical call scripts and communication content, historical profile data, runtime data including feedback, and the like, to generate conversation content that can be injected into a communication session given a set of feature data transformed from a set of application data and computing device data. The content generation AI model 332 is an example of AI Model 232 (see, for example, FIGS. 2A-2C). The historical communication content, historical profile data, runtime data including feedback are examples of data source 250 (see, for example, FIGS. 2A-2C). The training of the content generation AI model 332 may be evaluated based on sample response data 350, supplemental data 352, and the like.

In some examples and features of the instant solution, the content generation AI model 332 is trained using at least one neural network training method such as, but not limited to, gradient descent, stochastic gradient descent, random search, uniform search, basin hopping, and Krylov. In some examples and features of the instant solution, the content generation AI model 332 is a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, historical communication content, profile data, and the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of each utterance, and the like. The utterance may include a textual description of the audio from a historical video call, phone call, web call, meeting, or the like. The historical profile data may include profile data of the users that participated in the historical calls including which calls the users participated in. The runtime data may include feedback that is automatically captured by the software and/or that is received from a GUI, etc.

The model feedback records in the model feedback data 334 may include, but is not limited to, inputs entered via a GUI which indicate whether the responses and other content generated by the content generation AI model 332 is accurate or not. As another example, the model feedback data 334 may include data that is automatically detected by the software application. For example, the software application may detect a change in conversation and infer that the response provide by the content generation AI model 332 solved the issue, etc.

Once the content generation AI model 332 is trained and validated, it is deployed to an AI production system 230 (see, for example, FIGS. 2A-2C, 3) for use by a communication service 340. The communication service 340 is an example of software service.

In some examples and features of the instant solution, software app 310, running on computing device or source device 110, is an example of service client. The software app 310 may be a teleconferencing software application, a conferencing software application, a meeting software application, a call center software application, a mobile application, or the like. The software app 310 may enable users to speak with each other over a network such as a cellular telephone network, the Internet, and the like. The software app 310 may also display content on a GUI of the software app 310, such as communication content 312. The software app 310 may also display content generated by the content generation AI model 332.

In some examples and features of the instant solution, the communication service 340 receives data from the software app 310. The data may include, but is not limited to, call scripts, images, text, audio, and the like.

Additionally, the communication service 340 receives data about the computing device or source device 110. The device data may include, but is not limited to, the media access control (MAC) address and the source internet protocol (IP) address of the computing device.

For example, the communication service 340 may receive a communication from a software application such as an electronic message, an electronic form, application data, or the like. The communication service 340 may instantiate a communication subsystem 342 which extracts content from the communication and determines whether or not to the content is allowed to be sent to an exterior AI system, such as the content generation AI model 332. When the communication subsystem 342 determines to generate conversation content, the communication subsystem 342 executes a content generation 344 process which may call the content generation AI model 332 in the AI production system 230 for generative content that can be displayed, spoken, or the like, within the conversation. The call to the AI production system 230 may include content from the received communication. The content may include natural language content, transaction content, data from a profile database 360, a historical communication content database 362, a runtime database 370, and the like, in addition to the communication content.

In response to receiving the call, the content generation AI model 332 may generate a response to the input communication content that may include at least one of an utterance, a phrase, a script, a source code program, and the like, which can be output during the conversation. The response may be provided to the communication service 340 and output to a GUI of the software app 310, spoken by a talking bot via the software app 310, and the like.

In the example embodiments, the AI model that may be used to generate the response may be an open source AI model, such as a large language model (LLM). The system may use the LLM because it is quick. However, the use of the external LLM requires the data to leave the security of the system for the external host system of the LLM. To prevent sensitive data from being communicated to the external host system, the example embodiments may identify and redact sensitive data from the natural language input (and other input data), and send only the non-sensitive data to the LLM.

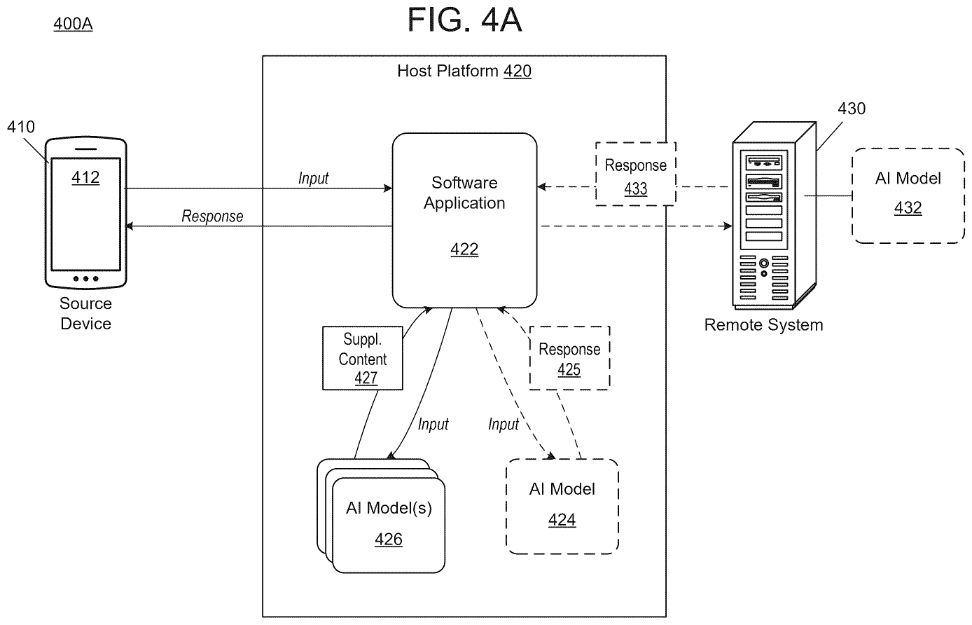

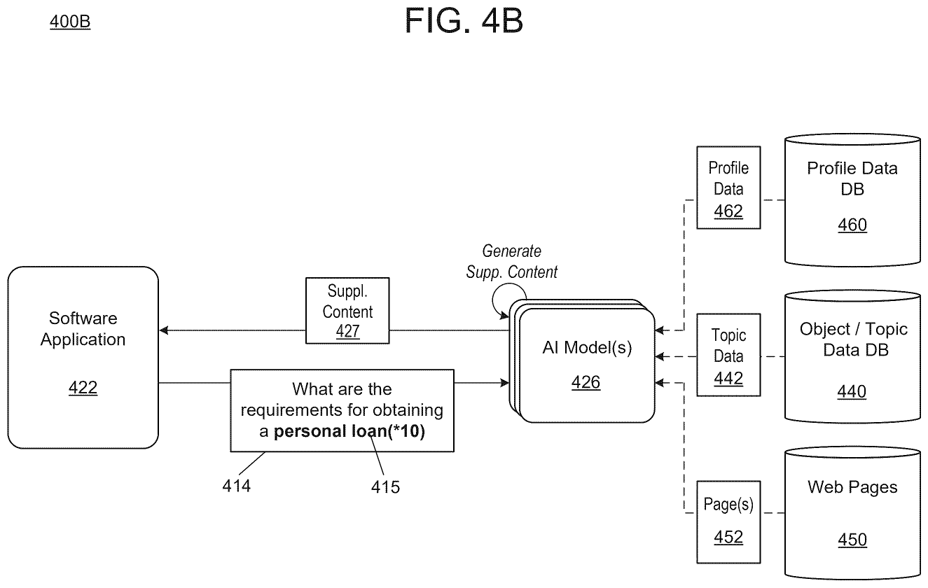

FIG. 4A illustrates a process 400A of generating supplemental content in parallel with generating a response to a natural language input according to the examples and features of the instant solution. Referring to FIG. 4A, a source device 410 may submit a natural language input to a software application 422 on a host platform 420. The software application 422 may be accessible to the source device 410 over a network. For example, the host platform 420 may host the software application as a web application which can be accessed by a browser installed on the source device 410. Here, a user can view a GUI or the like of the software application 422 on a display device 412 of the source device 410.

In response to receiving the natural language input from the source device 410, the software application 422 may provide the input to an AI model for purposes of generating a natural language response to the natural language input. There are multiple options for generating the natural language response. For example, the software application 422 may forward the input to a remote system 430 which hosts a remote AI model 432. Here, the remote system 430 may execute the remote AI model 432 on the input data to generate a response 433 (natural language response) and return the response 433 to the software application 422. As another example, the host platform 420 may contain its own AI model 424 hosted locally which can generate a response 425 and provide the response 425 to the software application 422.

In addition, the host platform 420 may also contain at least one AI model 426 configured to generate supplemental content 427 that is associated with the natural language input/response generated by the system. For example, the supplemental content 427 may include an alternative solution, an alternative product, an alternative service, an alternative system, etc. which can help the user solve a task that they are asking about. The at least one AI model 426 may be trained to generate supplemental content based on labelled training examples that include pairings between natural language content and supplemental content that is paired with/associated with the natural language content.

The combination of the response that is generated and the supplemental content that is generated by the at least one additional AI model may be output simultaneously to the source device 410. For example, both the response and the supplemental content may be rendered on a GUI of the display device 412 at the same time/simultaneously. In some embodiments, the system may interweave the supplemental content into the response such that the supplemental content becomes part of the response.

In one embodiment, the apparatus enhances response generation by integrating structured knowledge from a knowledge graph database. Upon receiving a natural language query from a source device 410, the software application 422, executing on the host platform 420, processes the input to generate a response. A first AI model 424 generates an initial response based on the natural language query. In parallel, a second AI model of the at least one AI model 426 queries a knowledge graph database to retrieve structured knowledge relevant to the query. This retrieved knowledge may include factual information, relationships between entities, domain-specific insights, or other structured data that supplement the initial response.

The software application 422 refines and augments the initial response by evaluating the relevance of the structured knowledge retrieved by the second AI model of the at least one AI model 426. A weighting mechanism is applied to assess the contextual alignment between the AI-generated response and the structured knowledge, prioritizing information that enhances factual accuracy and domain specificity. Using natural language processing (NLP) techniques, the software application 422 semantically integrates key elements from the structured knowledge into the response, ensuring coherence and readability.

The system applies entity resolution techniques to eliminate redundancies and inconsistencies while dynamically re-ranking response components based on relevance and informativeness. If multiple sources within the knowledge graph provide overlapping or conflicting data, the system resolves discrepancies by leveraging confidence scores, hierarchical knowledge structures, or predefined domain-specific rules.

Once refined, the augmented response is further processed to maintain fluency, logical consistency, and contextual appropriateness before being formatted as a combined supplemental response (output to 410). The final response seamlessly integrates the AI-generated content with the structured knowledge, enhancing accuracy, depth, and contextual relevance while reducing reliance on purely generative AI techniques.

FIG. 4B illustrates a process 400B of generating supplemental content with supplemental data according to the examples and features of the instant solution. Referring to FIG. 4B, the at least one AI model 426 may user various sources of data (e.g., content stored within at least one supplemental content database) for generating the supplemental content 427 including, but not limited to, a profile data database 460, an object/topic data database 440, a web pages database 450, or the like. In this example, the at least one AI model 426 may ingest at least one of profile data 462 from the profile data database 460, topic data 442 from the object/topic data database 440, and web pages 452 from the web pages database 450. As an example, the profile data 462 may include at least one parameter (e.g., a value, an account identifier, identity data, authentication data, validation data, etc.)

In this example, a natural language input 414 includes a request for requirements about obtaining a personal loan. In response to receiving the natural language input, the software application 422 may identify one or more keywords in the natural language input using rules, and adjust a model parameter, for example, add a weight 415 to the one or more keywords prior to providing the natural language input data to the at least one AI model 426. The weight 415 may cause the at least one AI model 426 to give the one or more keywords more priority or less priority. The weighting enables the system to dictate which natural language input content gets heavier consideration when generating the supplemental content. In response, the at least one AI model 426 captures additional content form any available data sources that is related to the natural language input, and generates the supplemental content 427 based therein. The at least one AI model 426 may be trained to enhance or otherwise supplement the response from the other AI model.

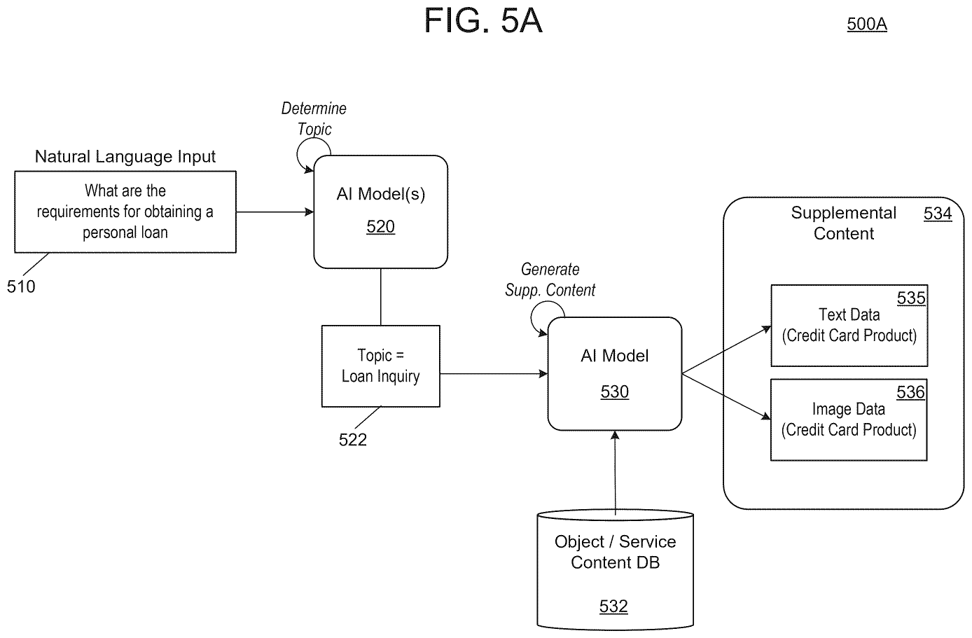

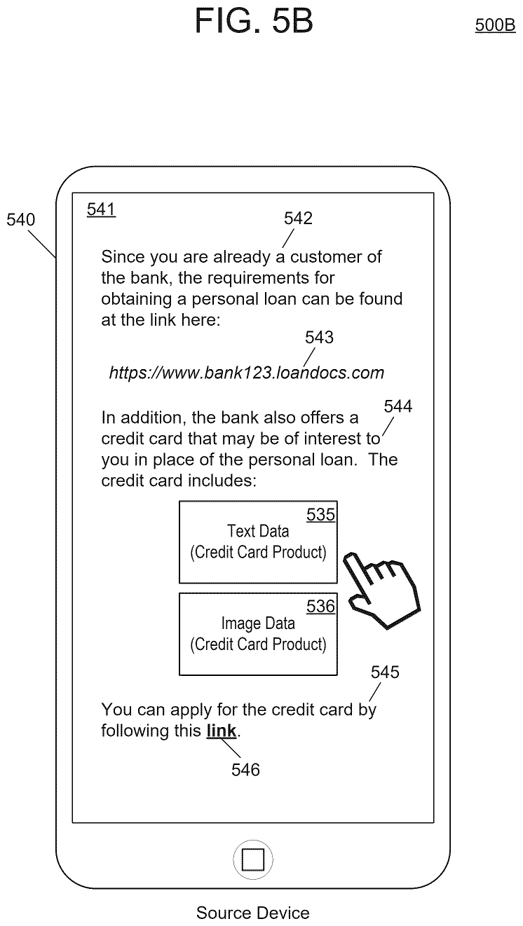

FIG. 5A illustrates a process 500A of generating both supplemental image and supplemental text content according to the examples and features of the instant solution. In the example of FIG. 5A, there is shown multiple AI models including a first AI model 520 and a second AI model 530. The multiple AI models may be an example of the at least one AI model 426 in the examples of FIGS. 4A-4B.

Referring now to FIG. 5A, the first AI model 520 is configured to determine a topic of a natural language input 510 input from a source device. The topic may include any of hundreds or thousands of different topics. Here, the first AI model 520 may determine a topic 522 and submit the topic 522 and the natural language input 510 to the second AI model 530. In this example, the second AI model 530 is in sequence, in a chain, with the first AI model 520. The software application may be responsible for chaining the output of the first AI model 520 to the input of the second AI model 530.

The second AI model 530 may receive the natural language input 510 and the topic 522 from the first AI model 520 and generate supplemental content 534 that includes both text data 535 content and image data 536 content of the supplemental content with respect to the topic. The second AI model 530 may obtain additional data about the supplemental content from an object/service content database 532 which contains manuals, pages, documents, etc. of content about objects, items, services, products, etc.

The supplemental content 534 may be returned to the display device of the source device along with the response that is generated in parallel by the other AI model.

FIG. 5B illustrates a process 500B of combining and outputting the supplemental content according to the examples and features of the instant solution. For example, FIG. 5B illustrates a process 500B of displaying the supplemental data on a display device 541 of a source device 540. Referring to FIG. 5B, the software application may intersperse the supplemental content (e.g., the text data 535 content and the image data 536 content) within the response content generated by the other AI model. In this example, the other AI model generates response content 542 and 543. Meanwhile, the supplemental content includes the content 544 and 545, and the text data 535 content and the image data 536 content positioned on the display device 541 underneath and/or interspersed with the response content.

In some embodiments, the second AI model 530 may also identify related web pages of content and insert hyperlinks 546 into the supplemental data that is generated and output to the source device. The hyperlinks 546 may navigate the source device field of view to a different web page, application page, or the like.

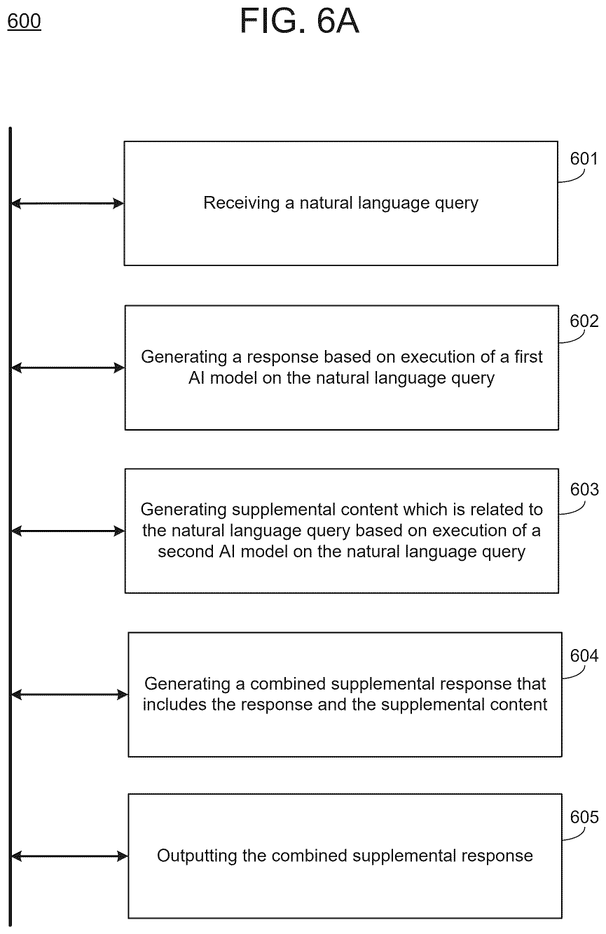

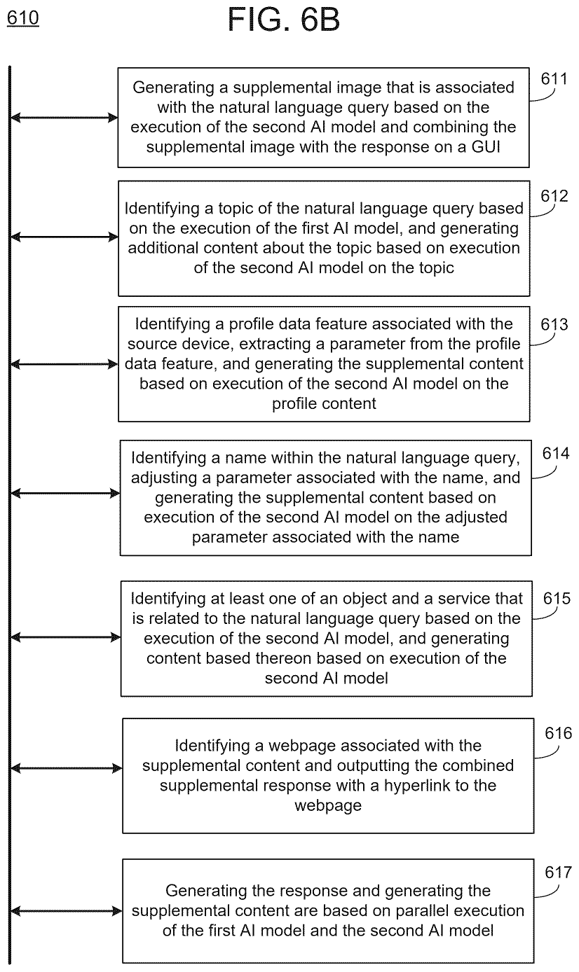

FIG. 6A illustrates a method 600 of generating a response with supplemental content according to the examples and features of the instant solution. As an example, the method 600 may be performed by a computing system, a software application, a server, a cloud platform, a combination of systems, and the like. Referring to FIG. 6A, in 601, the method may include receiving a natural language query from a source device. In 602, the method may include generating a response to the natural language query based on execution of a first artificial intelligence (AI) model on the natural language query. In 603, the method may include generating supplemental content which is related to the natural language query based on execution of a second AI model on the natural language query. In 604, the method may include generating a combined supplemental response that includes the response and the supplemental content. In 605, the method may include outputting the combined supplemental response to the source device.

FIG. 6B illustrates a method 610 of generating a response with supplemental content according to the examples and features of the instant solution. As an example, the method 610 may be performed by a computing system, a software application, a server, a cloud platform, a combination of systems, and the like. Referring to FIG. 6B, in 611, the method may include generating a supplemental image that is associated with the natural language query based on the execution of the second AI model and combining the supplemental image with the response on a GUI. In 612, the method may include identifying a topic of the natural language query based on the execution of the first AI model, and generating additional content about the topic based on execution of the second AI model on the topic.

In 613, the method may include identifying a profile data feature associated with the source device and extracting parameters from the profile data feature, and generating the supplemental content based on execution of the second AI model on the profile content. In 614, the method may include identifying a name within the natural language query and adding a weight to the name, wherein the generating the supplemental content comprises generating the supplemental content based on execution of the second AI model on the weight added to the name.

In 615, the method may include identifying at least one of an object and a service that is related to the natural language query based on the execution of the second AI model, and generating content about the at least one of the object and the service based on the execution of the second AI model. In 616, the method may include identifying a webpage associated with the supplemental content and outputting the combined supplemental response with a hyperlink to the webpage. In 617, the generating the response and the generating the supplemental content may be based on simultaneous execution of the first AI model and the second AI model.

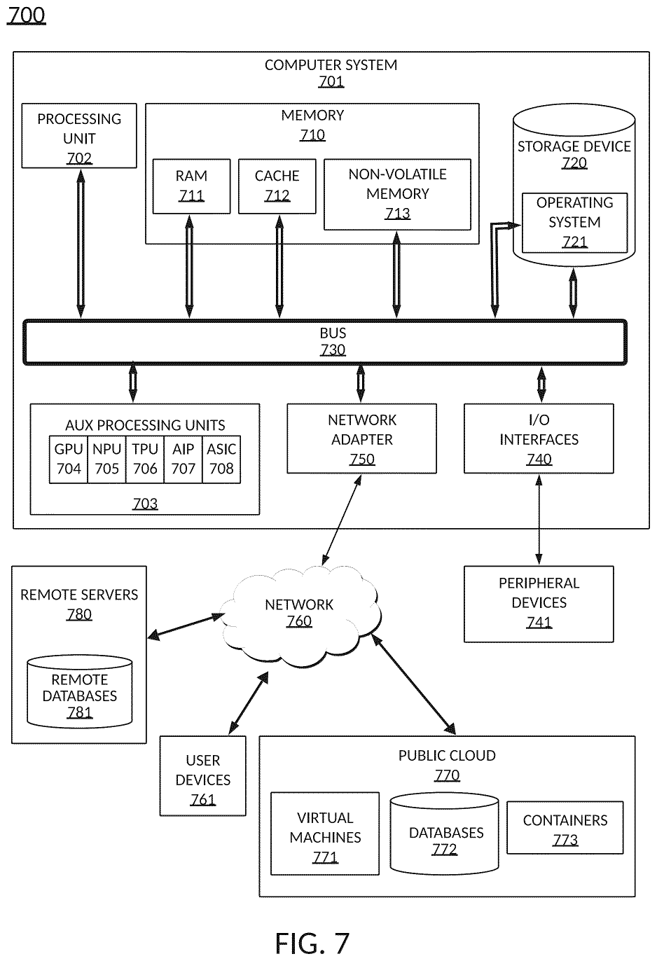

The examples and features of the instant solution may be implemented in at least one of the elements described or depicted herein, including for example, the elements described or depicted in FIG. 7. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 7 illustrates an example computer system architecture, which may represent or be integrated in any of the above-described components, etc.

FIG. 7 illustrates a computing environment according to the instant solution's example features, structures, or characteristics. FIG. 7 is not intended to suggest any limitation as to the scope of use or functionality of features, structures, or characteristics of the instant solution of the application described herein. Regardless, the computing environment 700 can be implemented to perform any of the functionalities described herein. In computing environment 700, there is a computer system 701, operational within numerous other general-purpose or special-purpose computing system environments or configurations.

Computer system 701 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 760 or querying a database. Depending upon the technology, the performance of a computer-implemented method may be distributed among multiple computers and among multiple locations. However, in this presentation of the computing environment 700, a detailed discussion is focused on a single computer, specifically computer system 701, to keep the presentation as simple as possible.

Computer system 701 may be located in a cloud, even though it is not shown in a cloud in FIG. 7. On the other hand, computer system 701 may not be in a cloud except to any extent as may be affirmatively indicated. Computer system 701 may be described in the general context of computer system-executable instructions, such as program modules, executed by a computer system 701. Generally, program modules may include routines, programs, objects, components, logic, data structures, and so on that perform tasks or implement certain abstract data types. As shown in FIG. 7, computer system 701 in computing environment 700 is shown in the form of a general-purpose computing device. The components of computer system 701 may include but are not limited to, at least one processor or processing unit 702, a system memory 710, and a bus 730 that couples various system components, including system memory 710 to processing unit 702.

Processing unit 702 includes at least one computer processor of any type now known or to be developed. The processing unit 702 may contain circuitry distributed over multiple integrated circuit chips. The processing unit 702 may also implement multiple processor threads and multiple processor cores. Cache 712 is a memory that may be in the processor chip package(s) or located “off-chip,” as depicted in FIG. 7. Cache 712 is typically used for data or code accessed by the threads or cores running on the processing unit 702. In some computing environments, processing unit 702 may be designed to work with qubits and perform quantum computing.

The Auxiliary Processing Units (APU) 703 may contain at least one Graphics Processing Unit (GPU) 704, Neural Processing Unit (NPU) 705, Tensor Processing Unit (TPU) 706, AI Processor (AIP) 707, or other Application Specific Integrated Circuit (ASIC) 708. The at least one APU 703 may contain circuitry distributed over multiple integrated circuit chips. Each APU 703 may implement multiple processor threads and multiple processor cores. Each APU 703 may include at least one of onboard memory, onboard memory cache, and onboard instruction cache. Each APU may be communicatively coupled to the system bus 730 and configure to communicate with other system components, including a processing unit 702, system cache 712, RAM 711, non-volatile RAM 713, operating system 721, Network adapter 750, and Input/Output interfaces 740. In some computing environments, at least one of the at least one APU 703 may be designed to work with qubits and perform quantum computing.

Memory 710 is any volatile memory now known or to be developed in the future. Examples include dynamic random-access memory (RAM) 711 or static type RAM 711. Typically, the volatile memory is characterized by random access, but this may not be the characterization unless affirmatively indicated. In computer system 701, memory 710 is in a single package. It is internal to computer system 701, but alternatively or additionally, the volatile memory may be distributed over multiple packages and/or located externally with respect to computer system 701. By way of example, memory 710 can be provided for reading from and writing to a non-removable, non-volatile magnetic media (shown as storage device 720, and typically called a “hard drive”). Memory 710 may include at least one program product having a set (e.g., at least one) of program modules configured to carry out the functions of various features, structures, or characteristics of the instant solution of the application. A typical computer system 701 may include cache 712, a specialized volatile memory generally faster than RAM 711 and generally located closer to the processing unit 702. Cache 712 stores frequently accessed data and instructions accessed by the processing unit 702 to speed up processing time. The computer system 701 may also include non-volatile memory 713 in the form of ROM, PROM, EEPROM, and flash memory. Non-volatile memory 713 often contains programming instructions for starting the computer, including the basic input/output system (BIOS) and information to start the operating system 721.

Computer system 701 may include a removable/non-removable, volatile/non-volatile computer storage device 720. For example, storage device 720 can be a non-removable, non-volatile magnetic media (not shown and typically called a “hard drive”). At least one data interface can connect it to the bus 730. In features, structures, or characteristics of the instant solution where computer system 701 has a large amount of storage (for example, where computer system 701 locally stores and manages a large database), then this storage may be provided by peripheral storage devices 720 designed for storing very large amounts of data, such as a storage area network (SAN) that is shared by multiple, geographically distributed computers.

The operating system 721 is software that manages computer system 701 hardware resources and provides common services for computer programs. Operating system 721 may take several forms, such as various known proprietary operating systems or open-source Portable Operating System Interface type operating systems that employ a kernel.

The bus 730 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 730 is the signal conduction path that allows the various components of computer system 701 to communicate.

Computer system 701 may communicate with at least one peripheral device, 741, via an input/output (I/O) interface, 740. Such devices may include a keyboard, a pointing device, a display, etc.; at least one device that enables a user to interact with computer system 701; and/or any devices (e.g., network card, modem, etc.) that enable computer system 701 to communicate with at least one other computing devices. Such communication can occur via I/O interface 740. As depicted, I/O interface 740 communicates with the other components of computer system 701 via bus 730.

Network adapter 750 enables the computer system 701 to connect and communicate with at least one network 760, such as a local area network (LAN), a wide area network (WAN), and/or a public network (e.g., the Internet). It bridges the computer's internal bus 730 and the external network, exchanging data efficiently and reliably. The network adapter 750 may include hardware, such as modems or Wi-Fi signal transceivers, and software for packetizing and/or de-packetizing data for communication network transmission. Network adapter 750 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 760 is any computer network that can receive and/or transmit data. Network 760 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 760 may be replaced and/or supplemented by LANs designed to communicate data between devices in a local area, such as a Wi-Fi network. The network 760 typically includes computer hardware such as copper transmission cables, optical transmission fibers, wireless transmission, routers, firewalls, switches, gateway computers, edge servers, and network infrastructure known now or to be developed in the future. Computer system 701 connects to network 760 via network adapter 750 and bus 730.

User devices 761 are any computer systems used and controlled by an end user in connection with computer system 701. For example, in a hypothetical case where computer system 701 is designed to provide a recommendation to an end user, this recommendation may typically be communicated from network adapter 750 of computer system 701 through network 760 to a user device 761, allowing user device 761 to display, or otherwise present, the recommendation to an end user. User devices can be a wide array, including personal computers, laptops, tablets, hand-held, mobile phones, etc.

A public cloud 770 is an on-demand availability of computer system resources, including data storage and computing power, without direct active management by the user. Public clouds 770 are often distributed, with data centers in multiple locations for availability and performance. Computing resources on public clouds 770 are shared across multiple tenants through virtual computing environments comprising virtual machines 771, databases 772, containers 773, and other resources. A container 773 is an isolated, lightweight software for running a software application on the host operating system 721. Containers 773 are built on top of the host operating system's kernel and contain software applications and some lightweight operating system APIs and services. In contrast, virtual machine 771 is a software layer with an operating system 721 and kernel. Virtual machines 771 are built on top of a hypervisor emulation layer designed to abstract a host computer's hardware from the operating software environment. Public clouds 770 generally offers databases 772, abstracting high-level database management activities. At least one element described or depicted in FIG. 7 can perform at least one of the actions, functionalities, or features described or depicted herein.

Remote servers 780 are any computers that serve at least some data and/or functionality over a network 760, for example, WAN, a virtual private network (VPN), a private cloud, or via the Internet to computer system 701. These networks 760 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 780 can also host remote databases 781, with the database located on one remote server 780 or distributed across multiple remote servers 780. Remote databases 781 are accessible from database client applications installed locally on the remote server 780, other remote servers 780, user devices 761, or computer system 701 across a network 760. An AI/ML model described or depicted here may reside fully or partially on any of the elements described or depicted in FIG. 7.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicably coupled to the memory, wherein the at least one processor is configured to:
receive a natural language query from a source device;
generate a response to the natural language query based on execution of a first artificial intelligence (AI) model on the natural language query;
generate supplemental content which is related to the natural language query based on execution of a second AI model on the natural language query;
generate a combined supplemental response that includes the response and the supplemental content; and
output the combined supplemental response to the source device.

2. The apparatus of claim 1, wherein the at least one processor is configured to generate a supplemental image that is associated with the natural language query based on the execution of the second AI model and combine the supplemental image with the response on a graphical user interface (GUI).

3. The apparatus of claim 1, wherein the at least one processor is configured to identify a topic of the natural language query based on the execution of the first AI model, and generate additional content about the topic based on execution of the second AI model on the topic.

4. The apparatus of claim 1, wherein the at least one processor is configured to identify a profile data feature associated with the source device, extract parameters from the profile data feature, and further generate the supplemental content based on execution of the second AI model on the parameters.

5. The apparatus of claim 1, wherein the at least one processor is configured to identify a name within the natural language query, adjust a parameter associated with the name, and generate the supplemental content based on execution of the second AI model on the adjusted parameter associated with the name.

6. The apparatus of claim 1, wherein the at least one processor is configured to identify at least one of an object and a service that is related to the natural language query based on the execution of the second AI model, and generate content about the at least one of the object and the service based on the execution of the second AI model.

7. The apparatus of claim 1, wherein the at least one processor is further configured to identify a webpage associated with the supplemental content and output the combined supplemental response with a hyperlink to the webpage, wherein an AI agent performs an action based on the combined supplemental response.

8. The apparatus of claim 1, wherein the at least one processor is configured to generate the response and generate the supplemental content based on parallel execution of the first AI model and the second AI model.

9. A method comprising:
receiving a natural language query from a source device;
generating a response to the natural language query based on execution of a first artificial intelligence (AI) model on the natural language query;
generating supplemental content which is related to the natural language query based on execution of a second AI model on the natural language query;
generating a combined supplemental response that includes the response and the supplemental content; and
outputting the combined supplemental response to the source device.

10. The method of claim 9, wherein the generating the supplemental content comprises generating a supplemental image that is associated with the natural language query based on the execution of the second AI model and the generating the combined supplemental response comprises combining the supplemental image with the response on a graphical user interface (GUI).

11. The method of claim 9, wherein the generating the response comprises identifying a topic of the natural language query based on the execution of the first AI model, and the generating the supplemental content comprises generating additional content about the topic based on execution of the second AI model on the topic.

12. The method of claim 9, wherein the method further comprises identifying a profile data feature associated with the source device and extracting parameters from the profile data feature, wherein the generating the supplemental content further comprises generating the supplemental content based on execution of the second AI model on the parameters.

13. The method of claim 9, wherein the method further comprises identifying a name within the natural language query and adjusting a parameter associated with the name, wherein the generating the supplemental content comprises generating the supplemental content based on execution of the second AI model on the adjusted parameter associated with the name.

14. The method of claim 9, wherein the generating the supplemental content comprises identifying at least one of an object and a service that is related to the natural language query based on the execution of the second AI model, and generating content about the at least one of the object and the service based on the execution of the second AI model.

15. The method of claim 9, wherein the method further comprises identifying a webpage associated with the supplemental content and outputting the combined supplemental response with a hyperlink to the webpage, wherein an AI agent performs an action based on the combined supplemental response.

16. The method of claim 9, wherein the generating the response and the generating the supplemental content are based on parallel execution of the first AI model and the second AI model.

17. A computer-readable storage medium comprising instructions which when executed by a processor cause the processor to perform:
receiving a natural language query from a source device;
generating a response to the natural language query based on execution of a first artificial intelligence (AI) model on the natural language query;
generating supplemental content which is related to the natural language query based on execution of a second AI model on the natural language query;
generating a combined supplemental response that includes the response and the supplemental content; and
outputting the combined supplemental response to the source device.

18. The computer-readable storage medium of claim 17, wherein the generating the supplemental content comprises generating a supplemental image that is associated with the natural language query based on the execution of the second AI model and the generating the combined supplemental response comprises combining the supplemental image with the response on a graphical user interface (GUI).

19. The computer-readable storage medium of claim 17, wherein the generating the response comprises identifying a topic of the natural language query based on the execution of the first AI model, and the generating the supplemental content comprises generating additional content about the topic based on execution of the second AI model on the topic.

20. The computer-readable storage medium of claim 17, wherein the processor is further configured to perform identifying a profile data feature associated with the source device and extracting parameters from the profile data feature, wherein the generating the supplemental content further comprises generating the supplemental content based on execution of the second AI model on the parameters.
